(19) United States
(12) Patent Application Publication
(10) Pub. No.: US 2012/0093259 A1
(43) Pub. Date: Apr. 19, 2012

(54) METHOD AND APPARATUS FOR TRANSMITTING CONTENT, METHOD AND APPARATUS FOR RECEIVING CONTENT, AND CONTENT SERVICE SYSTEM

(75) Inventors: Hyoungsoo LIM, Daejeon-si (KR); Heung Mook KIM, Daejeon-si (KR); Soo In LEE, Daejeon-si (KR)

(73) Assignee: Electronics and Telecommunications Research Institute, Daejeon-si (KR)

(21) Appl. No.: 13/277,065

(22) Filed: Oct. 19, 2011

(30) Foreign Application Priority Data
Oct. 19, 2010 (KR) 10-2010-0102157
Mar. 24, 2011 (KR) 10-2011-0026198

(51) Int. Cl. H04L 25/49; H04L 17/00

(52) U.S. Cl. 375/296; 375/316

(57) ABSTRACT

A method and an apparatus for transmitting contents, a method and an apparatus for receiving contents, and a content service system are provided. The method for transmitting contents includes converting first contents including distortion part contents in which at least an area of a specific part of source contents is subjected to distortion processing into a transmittable type through a transmission network to generate a first transmission signal; converting any one the source part contents that are the part contents corresponding to the part of the source contents and differential information between the source part contents and the distortion part contents into a transmittable type through the transmission network to generate the second transmission signal; and transmitting part information indicating the first transmission signal, the second transmission signal, and the part through the transmission network.

### CROSS-REFERENCE TO RELATED APPLICATIONS

This application claims the benefit of priority of Korean Patent Application No. 10-2010-0102157 filed on Oct. 19, 2010, and Korean Patent Application No. 10-2011-0026198 filed on Mar. 24, 2011, all of which are incorporated by reference in their entirety herein.

### BACKGROUND OF THE INVENTION

1. Field of the Invention

The present invention relates to a method and an apparatus for transmitting contents, a method and an apparatus for receiving contents, and a content service system, and more particularly, to a technology capable of serving non-distorted contents through information separately provided when a part of contents in videos, voices, or multimedia contents is intentionally distorted using broadcasting services.

2. Related Art

Generally, a digital broadcasting system may mean a system that transmits digital broadcasting signals to a terminal through a wired or wireless communication networks and enables a user to view or listen broadcasting programs in real time through the terminal receiving the transmitted broadcasting signals.

In the digital broadcasting system, contents, such as videos, voices, multimedia, or the like, which are provided through a broadcasting or communication system, target unspecified people, and thus, it may be not possible to accurately know information regarding users using the contents. As a result, there is a need to control a level of contents to meet a universally valid reference as maximally as possible. For example, the case of intentionally providing in advance a part of source contents, for example, original videos or voices such as mosaic processing or masking of videos, voice modulation of voices, or the like, may correspond to the level control of contents.

However, in the case in which the user wants to use the videos, the voices, and the data services that are not distorted, the distortion may be a factor that degrades the service level. Currently, a scrambling technology is applied to some services so as to provide non-distorted services to only paid subscribers. In this case, however, the transmitted signal is applied with the scrambling but includes all the previously non-distorted service data, such that users may unrestrictedly use the services as they are when users that cannot use the services illegally perform descrambling.

Due to the above problems, in the services targeting a wide class of users, such as radio wave services, or the like, a part of the contents is previously distorted and transmitted. In this case, however, it may not be possible to originally provide services to some users wanting to view complete contents, as described above.

### SUMMARY OF THE INVENTION

The present invention provides a method and an apparatus for transmitting contents, a method and an apparatus for receiving contents, and a content service method capable of satisfying various demands of users by additionally provide non-distorted contents to specific users such as paid subscribers while providing contents of which the specific portions are distorted to unspecified people, by transmitting contents including distorted part contents and information capable of replacing or recovering the distorted part contents with or to a non-distorted original through a transmission network.

In an aspect, there is provided a method for transmitting contents, including: converting first contents including distortion part contents in which at least an area of a specific part of source contents is subjected to distortion processing into a transmittable type through a transmission network to generate a first transmission signal; converting any one of source part contents that are the part contents corresponding to the part of the source contents and differential information between the source part contents and the distortion part contents into a transmittable type through the transmission network to generate a second transmission signal; and transmitting part information indicating the first transmission signal, the second transmission signal, and the part through the transmission network.

The method for transmitting contents may further include: receiving the source contents, the part information indicating the part of the source contents to which the distortion processing is subjected, and area information indicating at least an area to which the distortion processing is subjected; and generating the first contents including the distortion part contents in which at least an area of the part of the source contents is subjected to the distortion process based on the part information and the area information.

The method for transmitting contents may further include extracting the source part contents that are a portion corresponding to the part of the source contents based on the part information. Alternatively, the method for transmitting contents may further include generating differential information between the source part contents and the distortion part contents based on the part information and the area information.

The transmitting through the transmission network may include: combining the first transmission signal and the second transmission signal to generate a content transmission signal; and transmitting the generated content transmission signal through the transmission network.

In another aspect, there is provided an apparatus for transmitting contents, including: a first transmission signal generator converting first contents including distortion part contents in which at least an area of a specific part is subjected to distortion processing in source contents into a transmittable type through a transmission network to generate a first transmission signal; a second transmission signal generator converting any one of source part contents that are the part contents corresponding to the part in the source contents and differential information between the source part contents and the distortion part contents into a transmittable type through the transmission network to generate a second transmission signal; and a transmission processor transmitting part information indicating the first transmission signal, the second transmission signal, and the part through the transmission network.

The apparatus for transmitting contents may further include a first processor receiving the source contents, the part information indicating the part in which the distortion processing is performed in the source contents, and area information indicating at least an area to which the distortion processing is subjected and generating the first contents including the distortion part contents in which at least a portion of the image of the part of the source contents is subjected to the distortion process based on the part information and the area information.

The apparatus for transmitting contents may further include a second processor extracting the source part contents that are a portion corresponding to the part in the source contents based on the part information. The apparatus for transmitting contents may further include a second processor generating differential information between the source part contents and the distortion part contents based on the part information and the area information.

The transmission processor may combine the first transmission signal and the second transmission signal to generate a content transmission signal and transmits the generated content transmission signal through the transmission network.

In another aspect, there is provided a method for receiving contents, including: receiving a first transmission signal, a second transmission signal, and part information; extracting first contents including distortion part contents in which at least an area of a specific part of source contents is subjected to distortion processing from the first transmission signal; and extracting any one of source part contents that are part contents corresponding to the part of the source contents and differential information between the source part contents and the distortion part contents from second transmission signal.

The method for receiving contents may further include: replacing the distortion part contents included in the first contents with source part contents extracted from the second transmission signal to recover the source contents based on the part information indicating the part when a first mode signal is received, and transmitting the recovered source contents to a player. Alternatively, the method for receiving contents may further include: recovering the source contents based on differential information between the source part contents and the distortion part contents when a first mode signal is received; and transmitting the recovered source contents to a player. The method for receiving contents may further include transmitting the first contents to a player when a second mode signal is received.

The method for receiving contents may further include: extracting the first transmission signal and the second transmission signal from the content transmission signal, wherein the receiving may include receiving a content transmission signal including the first transmission signal and the second transmission signal.

In another aspect, there is provided an apparatus for receiving contents, including: a receiving processor receiving a first transmission signal, a second transmission signal, and part information; a first transmission signal processor recovering first contents including distortion part contents in which at least an area of a specific part of source contents is subjected to distortion processing from the first transmission signal; and a second transmission signal processor extracting any one of source part contents that are part contents corresponding to the part of the source contents and differential information between the source part contents and the distortion part contents from second transmission signal.

The apparatus for receiving contents may further include a content processor replacing the distortion part contents included in the first contents with source part contents extracted from the second transmission signal to recover the source contents based on the part information indicating the part when a first mode signal is received; and transmitting the recovered source contents to a player. Alternatively, the apparatus for receiving contents may further include a content processor recovering the source contents based on differential information between the source part contents and the distortion part contents when a first mode signal is received and transmitting the recovered source contents to a player.

The receiving processor may receive a content transmission signal including the first transmission signal and the second transmission signal and extract the first transmission signal and the second transmission signal from the content transmission signal.

In another aspect, there is provided a content service system, including: an apparatus for transmitting contents converting first contents including distortion part contents in which at least an area of a specific part is subjected to distortion processing in source contents into a transmittable type through a transmission network to generate a first transmission signal, converting any one of source part contents that are the part contents corresponding to the part in the source contents and differential information between the source part contents and the distortion part contents into a transmittable type through the transmission network to generate the second transmission signal, and transmitting part information indicating the first transmission signal, the second transmission signal, and the part through the transmission network; and an apparatus for receiving contents receiving the first transmission signal, the second transmission signal, and the part information from the apparatus for transmitting contents, recovering the first contents from the first transmission signal, and recovering any one of the source part contents and the differential information from the second transmission signal.

### BRIEF DESCRIPTION OF THE DRAWINGS

FIG. 1 is a block diagram showing a configuration of a content service system according to an exemplary embodiment of the present invention.

FIG. 2 is a block diagram showing a configuration of an apparatus for transmitting contents according to an exemplary embodiment of the present invention.

FIG. 3 is an exemplified diagram showing a video including a scene damaging to minors.

FIG. 4 is an exemplified diagram showing a state in which a problematic area is subjected to distortion processing.

FIG. 5 is a block diagram showing a configuration of an apparatus for receiving contents according to an exemplary embodiment of the present invention.

FIG. 6 is a flow chart for describing a flow of a method for transmitting contents according to the exemplary embodiment of the present invention.

FIG. 7 is a flow chart for describing a flow of a method for receiving contents according to the exemplary embodiment of the present invention.

FIG. 8 is a flow chart for describing a flow of a method for transmitting contents according to the exemplary embodiment of the present invention.

FIG. 9 is a flow chart for describing a flow of a method for receiving contents according to another exemplary embodiment of the present invention.

### DESCRIPTION OF EXEMPLARY EMBODIMENTS

Hereinafter, exemplary embodiments of the present invention will be described in detail with reference to the accompanying drawings so that those skilled in the art to which the present invention pertains can easily understand the technical matters of the present invention. Specific terms will be used in the exemplary embodiments of the present invention for clarity of the contents therein. However, the present invention is not limited to the specific terms selected therein but includes all technical synonyms operating in the same method so that each of the specific terms accomplish similar objects.

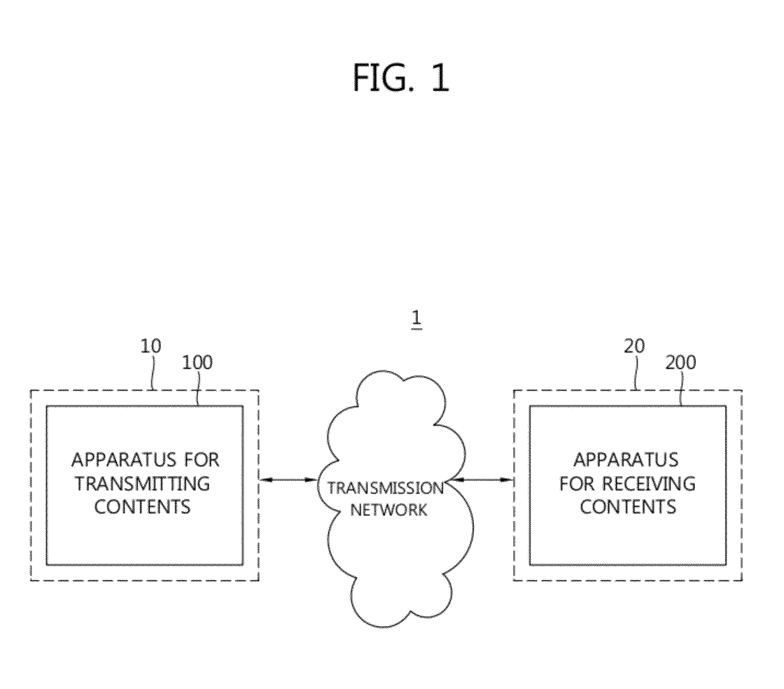

FIG. 1 is a block diagram showing a configuration of a content service system according to an exemplary embodiment of the present invention.

As shown in FIG. 1, a content service system 1 according to an exemplary embodiment of the present invention may include an apparatus 100 for transmitting contents interworking through a transmission network and an apparatus 200 for receiving contents. The transmission network may be a digital broadcasting network such as digital video broadcasting (DVB), advanced television systems committee (ATSC), a digital multimedia broadcasting (DMB), or the like.

The apparatus 100 for transmitting contents may be provided in a broadcasting service system 10 that provides broadcasting services. The apparatus 100 for transmitting contents may transmit signals for broadcasting content services to the apparatus 200 for receiving contents through the transmission network.

Meanwhile, the apparatus 200 for receiving contents may be provided in a user terminal 20. The user terminal 20 may mean devices provided at a user side for broadcasting services such as portable terminals, smart phones, PCs, set top boxes, or the like. The apparatus 200 for receiving contents may receive and process signals transmitted from the apparatus 100 for transmitting contents.

Hereinafter, configurations and operations of the apparatus 100 for transmitting contents and the apparatus 200 for receiving contents will be described in detail.

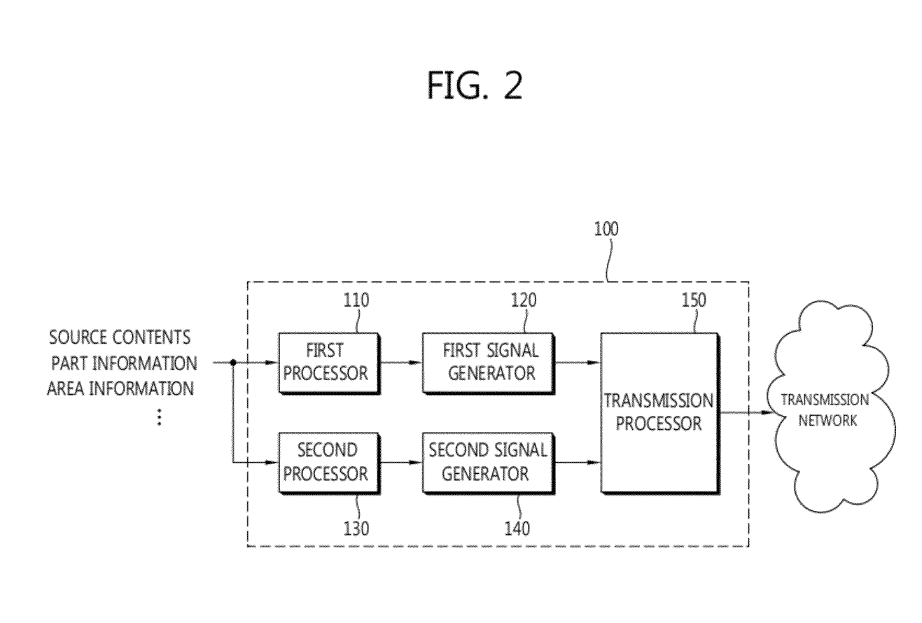

FIG. 2 is a block diagram showing a configuration of an apparatus for transmitting contents according to an exemplary embodiment of the present invention and shows a configuration of the apparatus 100 for transmitting contents shown in FIG. 1.

As shown in FIG. 2, the apparatus 100 for transmitting contents may include a first processor 110, a second processor 130, a first signal generator 120, a second signal processor 140, a transmission processor 150, or the like.

The first processor 110 may receive source contents, part information that is information indicating an part of the source contents to which distortion processing is subjected, and area information that is information indicating at least an area to which the distortion processing is subjected and may serve to generate the first contents based thereon.

The source contents may be multimedia contents including videos, voices, or the like, such as movies, broadcasting programs, or the like, or voice contents such as song, music, or the like, video contents, text contents, or the like. The exemplary embodiment of the present invention will be described under the assumption that the source contents are multimedia contents. However, this is only example of the exemplary embodiments and therefore, is not limited thereto. The source contents may be provided from a content database (not shown) of the broadcasting service system 10.

The part information may be information indicating an part in which the distortion processing is performed in the source contents. That is, the part information may be a frame interval, a play time interval (time stamp period), or the like, in which the intentional distortion processing is performed among the source contents, that is, the multimedia contents. For example, the part information may be information indicating whether videos from n-th frame to n-th frame of the source contents are subjected to the distortion processing or whether videos from any time to any time after playing are subjected to the distortion processing. The part information may be provided according to the information input from the user.

The area information may mean the information indicating the area in which the distortion processing is performed in the videos or the voices of the part corresponding to the part information. For example, the area information may include a range, coordinates information, or the like, indicating what portion is subjected to the distortion processing in the video of the frame belonging to the part in which the distortion processing is performed.

The first processor 110 may perform the distortion processing on the contents of some parts of the source contents, that is, the part designated by the part information based on the part information and the area information to generate the first contents. The first contents may mean contents in which at least an area of the videos, the voices, the texts, or the like, of the part corresponding to the part information in the source contents are subjected to the distortion processing. Among the first contents, the part in which the distortion processing is performed is referred to as distortion part contents. That is, the first contents are the same as the source contents in a portion other than the part corresponding to the part information but the part may be provided with the distortion processing contents.

For example, when it is assumed that the source contents are the multimedia contents configured by 100000 frame videos, the interval in which the distortion processing is performed according to the part information is from 10000-th frame to 10500-th frame, and the coordinates in which the video within the part information is subjected to the distortion processing is designated by the area information, the first processor 110 may receive the multimedia contents and performs the distortion processing on the videos from 10000-th frame to 10500-th frame of the multimedia contents according to the area information to generate the first contents. In this case, the video from 10000-th frame to 10500-th frame that are subjected to the distortion processing is the distortion part contents.

Meanwhile, the distortion processing may be mosaic processing and masking processing of the videos, the voices, and the texts or binding processing or warning sound (ringing masking) processing of voice, or the like. The first processor 110 may include a module having a distortion processing algorithm defined for the distortion processing.

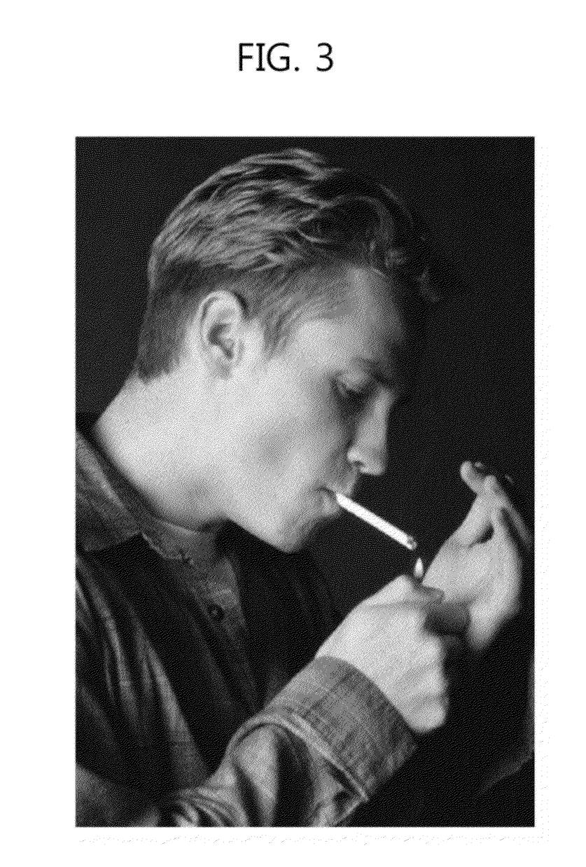

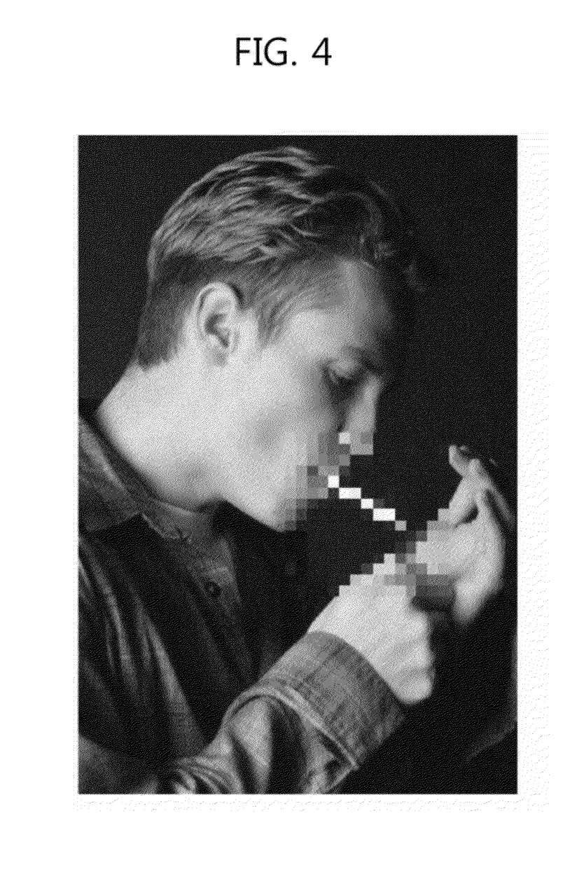

FIG. 3 is an exemplified diagram showing a video including a scene damaging to minors and FIG. 4 is an exemplified diagram showing a state in which a problematic area is subjected to distortion processing.

As shown in FIG. 3, a video including a smoking scene may have a bad effect on minors when being exposed to minors. Therefore, as shown in FIG. 4, a portion in which a tobacco is displayed may be subjected to the distortion processing by using a mosaic method.

The second processor 130 may receive the source contents and the part information and extract the source part contents that are a portion corresponding to the part of the source contents.

For example, when it is assumed that the source contents are the multimedia contents configured by 100000 frame videos and the part in which the distortion processing is performed is from 10000-th frame to 10500-th frame, the second processor 130 extracts the videos from 10000-th frame to 10500-th frame corresponding to the interval of the multimedia contents that are the source contents. In this case, the videos from 10000-th frame to 10500-th extracted from the source contents may mean the source part contents. That is, the distortion part contents and the source part contents are the video within the same interval, wherein the distortion part contents may be the distortion processed video and the source part contents may mean an original video.

Meanwhile, the second processor 130 may receive the source contents, the part information, and the area information and generate the differential information between the source part contents and the distortion part contents based on the part information and the area information. That is, the second processor 130 calculates the difference between the distortion part contents to which the distortion process is subjected and the source part contents that is an original.

For example, in the above-mentioned example, when the distortion part contents to which the distortion processing is subjected by the first processor 110 are the video from 10000-th frame to 10500-th frame of the source contents, the second processor 130 may calculate the difference between the videos of each frame from 10000-th frame to 10500-th frame to which the distortion processing is subjected and the videos of each frame from 10000-th frame to 10500-th frame of the source contents.

The first transmission signal generator 120 converts the first contents generated by the first processor 110, that is, the contents including the distortion part contents into a transmittable type through the transmission network to serve to generate the first transmission signal. That is, the first transmission signal generator 120 converts the first contents including the distortion part contents in which at least an area of the specific part of the source contents is subjected to the distortion processing into the transmittable type through the transmission network to generate the first transmission signal.

The second transmission signal generator 140 may convert the source part contents or the differential information extracted by the second processor 130 into the transmittable type through the transmission network to serve to generate the second transmission signal. That is, the second transmission signal generator 140 converts the source part contents that are the part contents corresponding to the part information of the source contents or the differential information between the source part contents and the distortion part contents into the transmittable type through the transmission network to generate the second transmission signal.

The transmission processor 150 may serve to transmit the first transmission signal generated by the first signal generator 120 and the second transmission signal, the part information, the area information generated by the second signal generator 140, or the like, to the apparatus for receiving contents through the transmission network.

The transmission processor 150 may combine the first transmission signal and the second transmission signal to generate the content transmission signal and transmit the generated content transmission signal through the transmission network. In this case, the part information, the area information, or the like, may be transmitted as separate signals.

Meanwhile, the transmission processor 150 may also transmit at least any one of the part information and the area information by including the part information and the area information in the content transmission signal in which the first transmission signal and the second transmission signal are combined.

The first transmission signal, the second transmission signal, the part information, the area information, or the like, that are transmitted by the transmission processor 140 are received by the apparatus for receiving contents and are then processed.

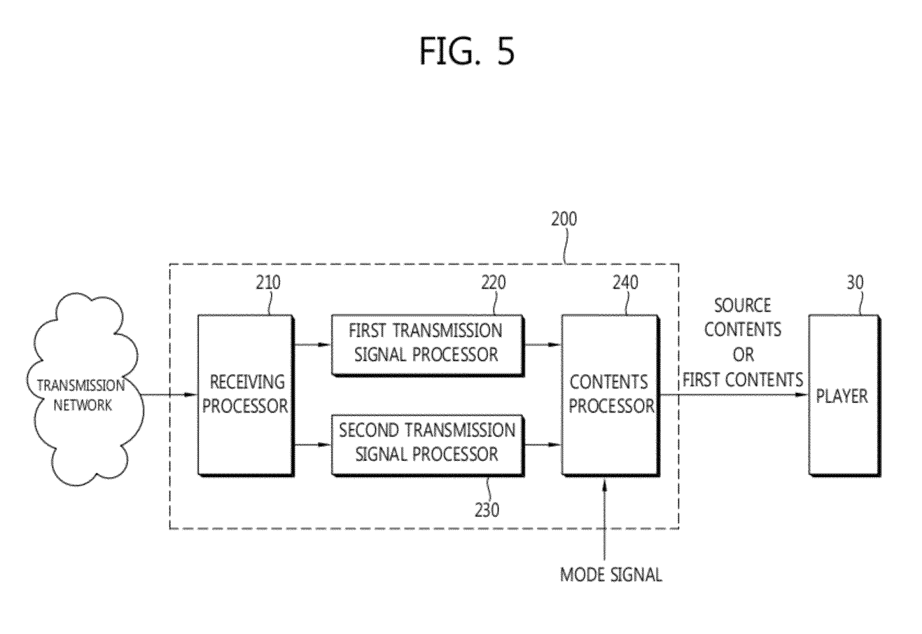

FIG. 5 is a block diagram showing a configuration of an apparatus for receiving contents according to an exemplary embodiment of the present invention and shows a configuration of the apparatus 200 for receiving contents shown in FIG. 1.

As shown in FIG. 5, the apparatus 200 for receiving contents may include a receiving processor 210, a first transmission signal processor 220, a second transmission signal processor 230, and a content processor 240, or the like.

The receiving processor 210 may receive the first transmission signal, the second transmission signal, the part information, the area information, or the like, that are transmitted from the apparatus 100 for transmitting contents and transmit the received information to the first transmission signal processor 220, the second transmission processor 230, or the content processor 240, or the like.

The signal and the information may be received as the separate signals, but when the content transmission signal including the first transmission signal and the second transmission signal is transmitted from the apparatus 100 for transmitting contents, the receiving processor 210 may receive the content transmission signal and then, separate the first transmission signal and the second transmission signal, respectively, from the received content transmission signal. In addition, when the part information or the area information is included in the content transmission signal, the receiving processor 210 may extract the part information or the area information included in the content transmission signal.

The first transmission signal processor 220 may serve to extract the first contents including the distortion part contents from the first transmission signal transmitted from the receiving processor 210. That is, the first transmission signal processor 220 recovers the first contents including the distortion part contents in which at least a portion of the specific part of the source contents is subjected to the distortion processing.

The second transmission signal processor 230 may extract the source part contents from the second transmission signal. That is, the second transmission signal processor 230 extracts the source part contents that are the original contents corresponding to the distortion part contents from the second transmission signal.

Meanwhile, the second transmission signal processor 230 may extract the differential information between the source part contents and the distortion part contents from the second transmission signal. That is, the second transmission signal processor 230 extracts the information recovering the original corresponding to the distorted areas of the distortion part contents from the second transmission signal.

The content processor 240 receives a mode signal and recovers the source contents according to the received mode signal to serve to transmit the recovered source contents to a player 30 within the user terminal 20 or transmit the first contents to the player 30.

The mode signal may be a first mode signal or a second mode signal. The first mode signal may mean a signal requesting the transmission of the source contents to which the distortion processing is not subjected to the player. The second mode signal may mean a notification signal requesting the transmission of the contents to which the distortion processing is subjected in the designated part, that is, the first contents, to the player.

The mode signal may be transmitted from a specific entity included in the user terminal, for example, a broadcasting service control module (not shown), or the like. The entity may transmit the first mode signal to the content processor 240 when the user terminal 20 is authorized as a permitted user, for example, a paid membership, an adult, or the like, capable of viewing the source contents. On the other hand, when the user terminal 20 is not authorized as the permitted user capable of viewing the source contents, the second mode signal may be transmitted to the content processor 240.

When the contents, that is, the first mode signal is received, the content processor 240 may replace the distortion part contents included in the first contents extracted from the first transmission signal with the source part contents extracted from the second transmission signal based on the part information to recover the source contents and transmit the recovered source contents to the player 30. That is, the content processor 240 recovers the source contents and then, transmits the recovered source contents to the player 30, by replacing the videos, the voices, or the like, of the distortion processed part of the first contents with the original videos, the voices, or the like, corresponding to the corresponding part.

When the information extracted from the second transmission signal is the differential information, the content processor 240 may recover the source contents by recovering the distortion part contents within the first contents extracted from the first transmission signals using the differential information extracted from the second transmission signal based on the part information and the area information and then, transmit the recovered source contents to the player 30. That is, the content processor 240 recovers the source contents by recovering the distorted portion of the distortion part contents based on the differential information that is the difference information between the source part contents and the distortion part contents and transmits the recovered source contents to the player 30.

Meanwhile, the content processor 240 may transmit the first contents extracted from the first transmission signal to the player 30 when the second mode signal is received. That is, when the first mode signal is received, the content processor 240 transmits the source contents to the player 30 and when the second mode signal is received, transmits the first contents to the player 30. Therefore, the user terminal 20 may play the source contents when the user terminal 20 is authorized as the permitted user capable of viewing the source contents and may play the contents including the first contents, that is, the distorted portion when the user terminal 20 is not authorized as the permitted user capable of viewing the source contents.

The content transmission system 1 including the apparatus 100 for transmitting contents and the apparatus 200 for receiving contents according to the exemplary embodiment of the present invention was described above. As described above, the content transmission system 1 can transmit and receive the first contents including the distorted part contents and the information capable of replacing or recovering the distorted part contents with or to the non-distorted original, for example, the source part contents or the differential information through the transmission network. Therefore, the content transmission system 1 may additionally provide the non-distorted contents to the specific users such as the paid subscribers while providing the distorted contents as the specific portions to the unspecified people.

Hereinafter, a method for transmitting contents will be described based on the apparatus 100 for transmitting contents and the apparatus 200 for receiving contents. In order to recover the first contents to the source contents in the apparatus 100 for transmitting contents, the transmitted information may also be the source part contents or the differential information as described above. Therefore, the case of transmitting and receiving the source part contents and the case of transmitting and receiving the differential information will be described as each exemplary embodiment.

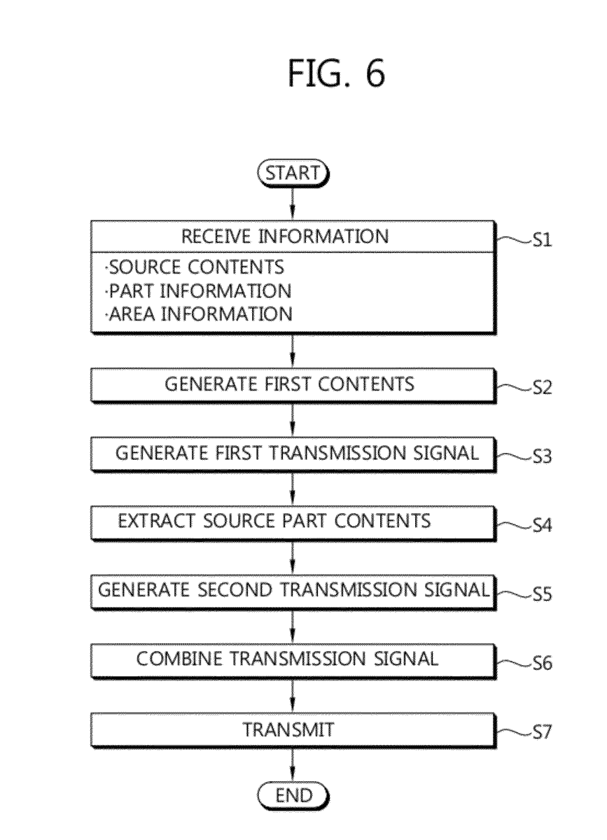

FIG. 6 is a flow chart for describing a flow of a method for transmitting contents according to the exemplary embodiment of the present invention.

As shown in FIG. 6, the apparatus 100 for transmitting contents may first receive the source contents, the part information that is information indicating the part of the source contents to which the distortion processing is subjected, and the area information that is information indicating at least an area in which the distortion processing is performed (S1).

The source contents may be multimedia contents including an image, a voice, or the like, such as movies, broadcasting programs, or the like, or voice contents such as song, music, or the like, image contents, text contents, or the like. The part information may be the information indicating the part in which the distortion processing is performed in the source contents, for example, the frame interval, the play time interval, or the like, in which the intentional distortion processing is performed when the source contents is the multimedia contents. The area information may include information indicating an area in which the distortion processing is performed in the video or the voice of the part corresponding to the part information, for example, the range, the coordinate information, or the like, indicating what portion of the video of the frame belonging to the interval in which the distortion processing is performed is subjected to the distortion processing

The apparatus 100 for transmitting contents may perform the distortion processing on at least an area of the contents of some parts of the source contents, that is, the part designated by the part information based on the received part information and area information to generate the first contents including the distortion part contents (S2). Then, the apparatus 100 for transmitting contents may convert the generated first contents, that is, the contents including the distortion part contents into the transmittable type through the transmission network to generate the first transmission signal (S3).

Meanwhile, the apparatus 100 for transmitting contents may extract the source part contents that are a portion corresponding to the part of the source contents, based on the part information (S4). Further, the apparatus 100 for transmitting contents may generate the second transmission signals by converting the extracted source part contents into the transmittable type through the transmission network (S5).

Next, the apparatus 100 for transmitting contents may combine the generated first transmission signal and second transmission signal to generate the content transmission signal (S6) and transmit the generated content transmission signal through the transmission network (S7). The content transmission signal may be provided with the part information, the area information, or the like. Meanwhile, the apparatus 100 for transmitting contents may transmit the first transmission signal, the second transmission signal, the part information, and the area information as the separate signals.

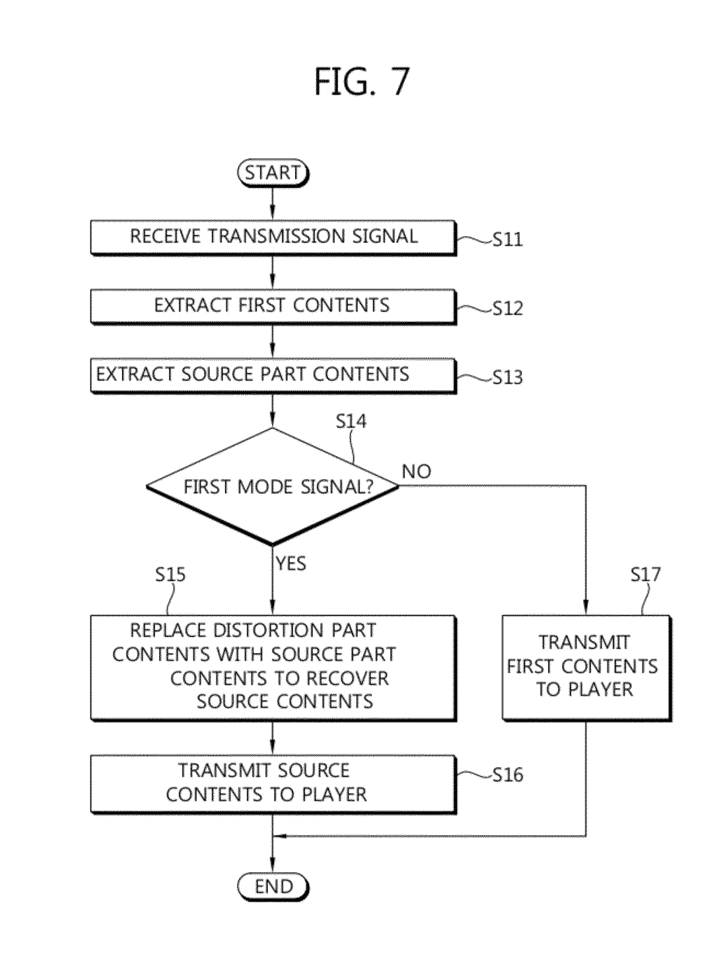

FIG. 7 is a flow chart for describing a flow of a method for receiving contents according to the exemplary embodiment of the present invention.

As shown in FIG. 7, the apparatus 200 for receiving contents may receive the first transmissions signal, the second transmission signal, the part information, the area information, or the like, that are transmitted from the apparatus 100 for transmitting contents (S11).

The signals or the information may also be received as the separate signals and the combined signal and when they are received as the combined signal, the apparatus 200 for receiving contents may separate each signal or information.

For example, when the apparatus 100 for transmitting content transmits the content transmission signal including the first transmission signal and the second transmission signal, the apparatus 200 for receiving contents receives the content transmission signal and then, separate the first transmission signal and the second transmission signal, respectively, from the received content transmission signal. In addition, when the part information or the area information is included in the content transmission signal, the apparatus 200 for receiving contents may extract the part information or the area information included in the content transmission signal.

Next, the apparatus 200 for receiving contents may extract the first contents including the distortion part contents from the first transmissions signal (S12). That is, the apparatus 200 for receiving contents extracts the first contents including the distortion part contents in which at least an area of the specific part of the source contents is subjected to the distortion processing.

On the other hand, the apparatus 200 for receiving contents may extract the source part contents from the second transmission signal (S13). That is, the apparatus 200 for receiving contents extracts the source part contents that are the original contents corresponding to the distortion part contents from the second transmission signal.

Then, the apparatus 200 for receiving contents may receive the mode signal and determine whether the received mode signal is the first mode signal or the second mode signal (S14).

In this case, when the received mode signal is the first mode signal, the apparatus 200 for receiving contents may recover the source contents by replacing the distortion part contents included in the first contents extracted from the first transmission signal with the source part contents extracted from the second transmission signal based on the part information (S15). Further, the apparatus 200 for receiving contents may transmit the recovered source contents to the player 30 (S16). Therefore, the player 30 may play the source contents.

Meanwhile, when the received mode signal is the second mode signal, the apparatus 200 for receiving contents may transmit the first contents extracted from the first transmission signal to the player 30 (S17). Therefore, in this case, the player 30 plays all the contents including the first contents, that is, the distortion part contents.

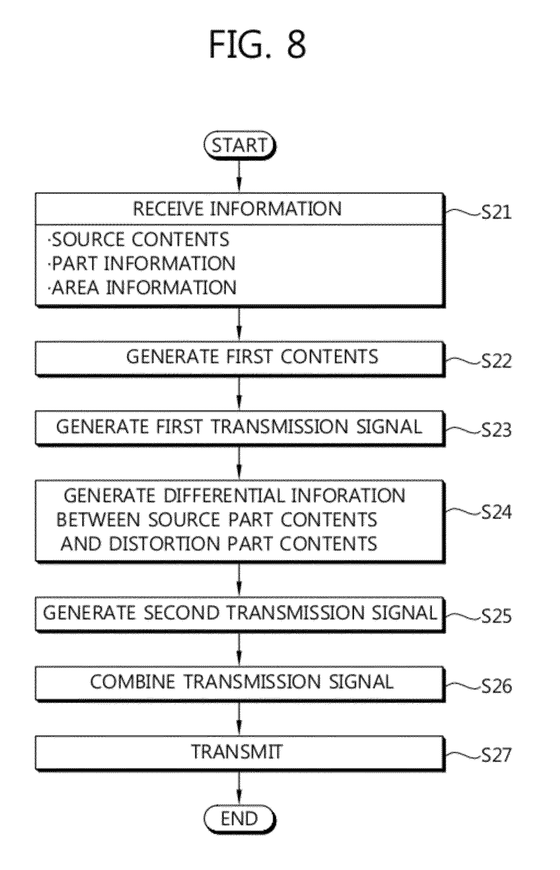

FIG. 8 is a flow chart for describing a flow of a method for transmitting contents according to the exemplary embodiment of the present invention.

As shown in FIG. 8, the apparatus 100 for transmitting contents may first receive the source contents, the part information that is information indicating the part of in the source contents to which the distortion processing is subjected, and the area information that is information indicating at least an area in which the distortion processing is performed (S21).

As described above, the source contents may be the multimedia contents including the videos, the voices, or the like, such as movies, broadcasting programs, or the like, or voice contents such as song, music, or the like, image contents, text contents, or the like. The part information may be the information indicating the part in which the distortion processing is performed in the source contents, for example, the frame interval, the play time interval, or the like, in which the intentional distortion processing is performed when the source contents is the multimedia contents. The area information may include information indicating an area in which the distortion processing is performed in the video or the voice of the part corresponding to the part information, for example, the range, the coordinate information, or the like, indicating what portion of the video of the frame belonging to the part in which the distortion processing is performed is subjected to the distortion processing

The apparatus 100 for transmitting contents may perform the distortion processing on at least an area of the contents of some parts of the source contents, that is, the part designated by the part information based on the received part information and area information to generate the first contents including the distortion part contents (S22). Then, the apparatus 100 for transmitting contents may convert the generated first contents, that is, the contents including the distortion part contents into the transmittable type through the transmission network to generate the first transmission signal (S23).

Meanwhile, the apparatus 100 for transmitting contents may generate the differential information between the source part contents and the distortion part contents based on the part information and the area information (S24). That is, the apparatus 100 for transmitting contents calculates the difference between the distortion part contents to which the distortion process is subjected and the source part contents that is an original. Then, the apparatus 100 for transmitting contents may convert the generated differential information into the transmittable type through the transmission network to generate the second transmission signal (S25).

Next, the apparatus 100 for transmitting contents may combine the generated first transmission signal and second transmission signal to generate the content transmission signal (S26) and transmit the generated content transmission signal through the transmission network (S27). The content transmission signal may be provided with the part information, the area information, or the like. Meanwhile, the apparatus 100 for transmitting contents may transmit the first transmission signal, the second transmission signal, the part information, and the area information as the separate signals.

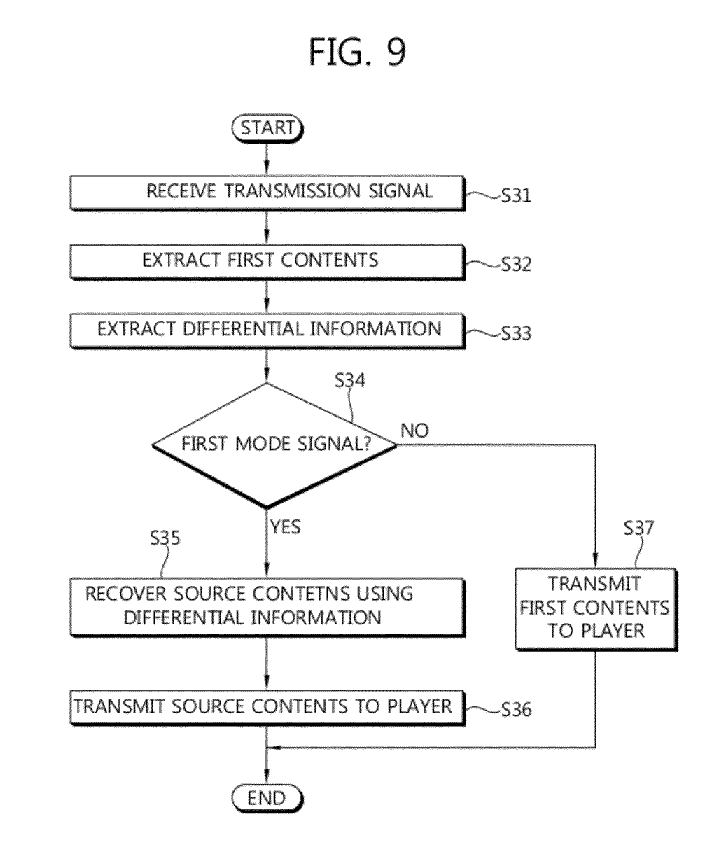

FIG. 9 is a flow chart for describing a flow of a method for receiving contents according to another exemplary embodiment of the present invention.

As shown in FIG. 9, the apparatus 200 for receiving contents may receive the first transmissions signal, the second transmission signal, the part information, the area information, or the like, that are transmitted from the apparatus 100 for transmitting contents (S31).

The signals or the information may also be received as the separate signals and the combined signal and when they are received as the combined signal, the apparatus 200 for receiving contents may separate each signal or information.

For example, when the apparatus 100 for transmitting content transmits the content transmission signal including the first transmission signal and the second transmission signal, the apparatus 200 for receiving contents receives the content transmission signal and then, separate the first transmission signal and the second transmission signal, respectively, from the received content transmission signal. In addition, when the part information or the area information is included in the content transmission signal, the apparatus 200 for transmitting contents may extract the part information or the area information included in the content transmission signal.

Next, the apparatus 200 for receiving contents may extract the first contents including the distortion part contents from the first transmissions signal (S32). That is, the apparatus 200 for receiving contents recovers the first contents including the distortion part contents in which at least an area of the specific part of the source contents is subjected to the distortion processing.

On the other hand, the apparatus 200 for receiving contents may extract the differential information from the second transmission signal (S33). The differential information is a signal indicating the information on the difference between the distortion part contents and the source part contents corresponding thereto. That is, apparatus 200 for receiving contents extracts the information recovering the original corresponding to the distorted areas of the distortion part contents from the second transmission signal.

Then, the apparatus 200 for receiving contents may receive the mode signal and determine whether the received mode signal is the first mode signal or the second mode signal (S34).

In this case, when the received mode signal is the first mode signal, the apparatus 200 for receiving contents may perform the source recovery by recovering the distortion part contents included in the first contents extracted from the first transmission signal based on the part information and the area information to the source part contents using the differential information extracted from the second transmission signal (S35). Further, the apparatus 200 for receiving contents may transmit the recovered source contents to the player 30 (S36). Therefore, the player 30 may play the source contents.

Meanwhile, when the received mode signal is the second signal, the apparatus 200 for receiving contents may transmit the first contents extracted from the first transmission signal to the player 30 (S37). Therefore, in this case, the player 30 plays all the contents including the first contents, that is, the distortion part contents.

As described above, the exemplary embodiments of the present invention can transmit the first contents including the distorted part contents and the information capable of replacing or recovering the distorted part contents with or to the non-distorted original, for example, the source part contents or the differential information through the transmission network. Therefore, the exemplary embodiments of the present invention can satisfy the various demands of the users by additionally providing the non-distorted contents to the specific users such as the paid subscribers, or the like, while providing the contents of which the specific portions are distorted to unspecified people.

While the present invention has been shown and described in connection with the embodiments, it will be apparent to those skilled in the art that modifications and variations can be made without departing from the spirit and scope of the invention as defined by the appended claims. Therefore, coming variations of the exemplary embodiments of the present invention will not depart from the technology of the present invention.

What is claimed is:

1. A method for transmitting contents, comprising:
converting first contents including distortion part contents in which at least an area of a specific part of source contents is subjected to distortion processing into a transmittable type through a transmission network to generate a first transmission signal;
converting any one of source part contents that are the part contents corresponding to the part of the source contents and differential information between the source part contents and the distortion part contents into a transmittable type through the transmission network to generate a second transmission signal; and
transmitting part information indicating the first transmission signal, the second transmission signal, and the part through the transmission network.

2. The method of claim 1, further comprising:
receiving the source contents, the part information indicating the part of the source contents to which the distortion processing is subjected, and area information indicating at least an area to which the distortion processing is subjected; and
generating the first contents including the distortion part contents in which at least an area of the part of the source contents is subjected to the distortion process based on the part information and the area information.

3. The method of claim 2, further comprising extracting the source part contents that are a portion corresponding to the part of the source contents based on the part information.

4. The method of claim 2, further comprising generating differential information between the source part contents and the distortion part contents based on the part information and the area information.

5. The method of claim 1, wherein the transmitting through the transmission network includes:
combining the first transmission signal and the second transmission signal to generate a content transmission signal; and
transmitting the generated content transmission signal through the transmission network.

6. An apparatus for transmitting contents, comprising:
a first transmission signal generator converting first contents including distortion part contents in which at least an area of a specific part is subjected to distortion processing in source contents into a transmittable type through a transmission network to generate a first transmission signal;
a second transmission signal generator converting any one of source part contents that are the part contents corresponding to the part in the source contents and differential information between the source part contents and the distortion part contents into a transmittable type through the transmission network to generate a second transmission signal; and
a transmission processor transmitting part information indicating the first transmission signal, the second transmission signal, and the part through the transmission network.

7. The apparatus of claim 6, further comprising a first processor receiving the source contents, the part information indicating the part in which the distortion processing is performed in the source contents, and area information indicating at least an area to which the distortion processing is subjected and generating the first contents including the distortion part contents in which at least an area of the part of the source contents is subjected to the distortion process based on the part information and the area information.

8. The apparatus of claim 7, further comprising a second processor extracting the source part contents that are a portion corresponding to the part in the source contents based on the part information.

9. The apparatus of claim 7, further comprising a second processor generating differential information between the source part contents and the distortion part contents based on the part information and the area information.

10. The apparatus of claim 6, wherein the transmission processor combines the first transmission signal and the second transmission signal to generate a content transmission signal and transmits the generated content transmission signal through the transmission network.

11. A method for receiving contents, comprising:
receiving a first transmission signal, a second transmission signal, and part information;
extracting first contents including distortion part contents in which at least an area of a specific part of source contents is subjected to distortion processing from the first transmission signal; and
extracting any one of source part contents that are part contents corresponding to the part of the source contents and differential information between the source part contents and the distortion part contents from second transmission signal.

12. The method of claim 11, further comprising:
replacing the distortion part contents included in the first contents with source part contents extracted from the second transmission signal to recover the source contents based on the part information indicating the part when a first mode signal is received; and
transmitting the recovered source contents to a player.

13. The method of claim 11, further comprising:
recovering the source contents based on differential information between the source part contents and the distortion part contents when a first mode signal is received; and
transmitting the recovered source contents to a player.

14. The method of claim 11, further comprising transmitting the first contents to a player when a second mode signal is received.

15. The method of claim 11, further comprising extracting the first transmission signal and the second transmission signal from the content transmission signal,
wherein the receiving includes receiving a content transmission signal including the first transmission signal and the second transmission signal.

16. An apparatus for receiving contents, comprising:
a receiving processor receiving a first transmission signal, a second transmission signal, and part information;
a first transmission signal processor recovering first contents including distortion part contents in which at least an area of a specific part of source contents is subjected to distortion processing from the first transmission signal; and
a second transmission signal processor extracting any one of source part contents that are part contents corresponding to the part of the source contents and differential information between the source part contents and the distortion part contents from second transmission signal.

17. The apparatus of claim 16, further comprising a content processor replacing the distortion part contents included in the first contents with source part contents extracted from the second transmission signal to recover the source contents based on the part information indicating the part when a first mode signal is received, and transmitting the recovered source contents to a player.

18. The apparatus of claim 16, further comprising a content processor recovering the source contents based on differential information between the source part contents and the distortion part contents when a first mode signal is received and transmitting the recovered source contents to a player.

19. The apparatus of claim 16, wherein the receiving processor receives a content transmission signal including the first transmission signal and the second transmission signal and extracts the first transmission signal and the second transmission signal from the content transmission signal.

20. A content service system, comprising:
an apparatus for transmitting contents converting first contents including distortion part contents in which at least an area of a specific part is subjected to distortion processing in source contents into a transmittable type through a transmission network to generate a first transmission signal, converting any one of source part contents that are the part contents corresponding to the part in the source contents and differential information between the source part contents and the distortion part contents into a transmittable type through the transmission network to generate the second transmission signal, and transmitting part information indicating the first transmission signal, the second transmission signal, and the part through the transmission network; and
an apparatus for receiving contents receiving the first transmission signal, the second transmission signal, and the part information from the apparatus for transmitting contents, recovering the first contents from the first transmission signal, and recovering any one of the source part contents and the differential information from the second transmission signal.
